(19) United States
(12) Patent Application Publication
(10) Pub. No.: US 2015/0227530 A1
(43) Pub. Date: Aug. 13, 2015

(54) Address Book Ranking Method and Apparatus

(71) Applicant: Huawei Technologies Co., Ltd., Shenzhen (CN)

(72) Inventors: Zhirong Liu, Shenzhen (CN); Liangwei Wang, Shenzhen (CN)

(21) Appl. No.: 14/696,748

(22) Filed: Apr. 27, 2015

Related U.S. Application Data
(63) Continuation of application No. PCT/CN2014/074928, filed on Apr. 8, 2014.

(30) Foreign Application Priority Data
Apr. 9, 2013 (CN) 201310121249.3

(51) Int. Cl. G06F 17/30

(52) U.S. Cl. CPC G06F 17/3053; G06F 17/30702; G06F 17/30867

(57) ABSTRACT

An address book ranking method and apparatus are provided, which relate to the field of communications technologies and are convenient for a user to quickly find a desired contact when a capacity of an address book is large. The address book ranking method includes acquiring profile information and communication information of contacts in an address book; and ranking the contact according to the profile information and the communication information. The present invention may be applied to an address book.

### CROSS-REFERENCE TO RELATED APPLICATIONS

This application is a continuation of International Application No. PCT/CN2014/074928, filed on Apr. 8, 2014, which claims priority to Chinese Patent Application No. 201310121249.3, filed on Apr. 9, 2013, both of which are hereby incorporated by reference in their entireties.

### TECHNICAL FIELD

The present invention relates to the field of communications technologies, and in particular, to an address book ranking method and apparatus.

### BACKGROUND

Today, with the rapid development of information technologies, an address book has become one of main tools for managing personal or enterprise communication information. The personal or enterprise communication information is stored in a corresponding communication system or communication device by using an address book technology, so as to facilitate a user in consulting and management.

A current address book is generally ranked according to a storage order of contacts or an order of contacts' names in phonetic letters. With an increase of a capacity of contacts stored in an address book, the foregoing ranking manner is not convenient for a user to quickly find a desired contact in the large address book.

### SUMMARY

Embodiments of the present invention mainly aim to facilitate a user in quickly finding a desired contact when a capacity of an address book is large. To achieve the foregoing objective, the following technical solutions are used in the embodiments of the present invention.

According to a first aspect of the present invention, an address book ranking method is provided, including acquiring profile information and communication information of contacts in an address book; and ranking the contacts according to the profile information and the communication information of the contacts.

In a first possible implementation manner of the first aspect of the present invention, the ranking the contacts according to the profile information and the communication information of the contacts includes calculating communication distances between a user and the contacts according to the profile information and the communication information; and ranking the contacts according to the communication distances.

In a second possible implementation manner of the first aspect of the present invention, the profile information includes one or more pieces of the following information of the contact: an enterprise to which the contact belongs, a department to which the contact belongs, and a position of the contact.

With reference to the first aspect and the first possible implementation manner of the first aspect of the present invention, in a third possible implementation manner of the first aspect of the present invention, before the acquiring profile information and communication information of contacts in an address book, the method further includes receiving a search condition entered by the user; and searching for a contact corresponding to the search condition; and the acquiring profile information and communication information of contacts in an address book includes acquiring profile information and communication information of the contact, corresponding to the search condition, in the address book.

With reference to the first possible implementation manner of the first aspect of the present invention, in a fourth possible implementation manner of the first aspect of the present invention, after the ranking the contacts according to the communication distances, the method further includes receiving a search condition entered by the user; searching for a contact corresponding to the search condition; and acquiring, from the ranking list, a sub-ranking list of the contact corresponding to the search condition.

With reference to the third or the fourth possible implementation manner of the first aspect of the present invention, in a fifth possible implementation manner of the present invention, after the receiving a search condition entered by the user, the method includes determining whether a contact meeting the search condition exists in the address book; and the searching for a contact corresponding to the search condition includes, when the contact meeting the search condition does not exist in the address book, searching for a contact meeting a condition similar to the search condition.

Corresponding to the foregoing method, a second aspect of the present invention further provides an address book ranking apparatus, including an information acquiring unit configured to acquire profile information and communication information of contacts in an address book; and a ranking unit configured to rank the contacts according to the profile information and the communication information of the contacts.

In a first possible implementation manner of the second aspect of the present invention, the ranking unit includes a calculating module and a ranking module; the calculating module is configured to calculate communication distances between a user and the contacts according to the profile information and the communication information; and the ranking module is configured to rank the contacts according to the communication distances.

In a second possible implementation manner of the second aspect of the present invention, the profile information includes one or more pieces of the following information of the contact: an enterprise to which the contact belongs, a department to which the contact belongs, and a position of the contact.

With reference to the second aspect and the first possible implementation manner of the second aspect of the present invention, in a third possible implementation manner of the second aspect of the present invention, the apparatus further includes a receiving unit configured to, before the information acquiring unit acquires the profile information and the communication information of the contact in the address book, receive a search condition entered by the user; and a searching unit configured to search for a contact corresponding to the search condition; where the information acquiring unit is configured to acquire profile information and communication information of the contact, corresponding to the search condition, in the address book.

With reference to the second possible implementation manner of the second aspect of the present invention, in a fourth possible implementation manner of the second aspect of the present invention, the apparatus further includes a receiving unit configured to, after the ranking module ranks the contacts according to the communication distances, receive a search condition entered by the user; a searching unit configured to search for a contact corresponding to the search condition; and a sub-ranking list acquiring unit configured to acquire, from the ranking list, a sub-ranking list of the contact corresponding to the search condition.

With reference to the third or the fourth possible implementation manner of the second aspect of the present invention, in a fifth possible implementation manner of the second aspect of the present invention, the apparatus further includes a determining unit configured to, after the receiving a search condition entered by the user, determine whether a contact meeting the search condition exists in the address book; where the searching unit is configured to, when the determining unit determines that the contact meeting the search condition does not exist in the address book, search for a contact meeting a condition similar to the search condition.

According to the address book ranking method and apparatus that are provided by the embodiments of the present invention, in the ranking method, contacts are ranked based on profile information and communication information of the contacts; a ranking result comprehensively reflects a probability that a user communicates with the contacts, which can ensure that when consulting an address book, the user quickly find a desired contact by using the ranking result.

### BRIEF DESCRIPTION OF THE DRAWINGS

To describe the technical solutions in the embodiments of the present invention or in the prior art more clearly, the following briefly introduces the accompanying drawings required for describing the embodiments or the prior art. The accompanying drawings in the following description merely show some embodiments of the present invention, and a person of ordinary skill in the art may still derive other drawings from these accompanying drawings without creative efforts.

FIG. 1 is a flowchart of an address book ranking method according to an embodiment of the present invention;

FIG. 2 is a flowchart of an address book ranking method according to another embodiment of the present invention;

FIG. 3 is a block diagram of a principle of a machine learning method used in the embodiment in FIG. 2;

FIG. 4 is a flowchart of an address book ranking method according to another embodiment of the present invention;

FIG. 5 is a flowchart of an address book ranking method according to still another embodiment of the present invention;

FIG. 6 is a flowchart of an address book ranking method according to still another embodiment of the present invention;

FIG. 7 is a structural block diagram of an address book ranking apparatus according to an embodiment of the present invention;

FIG. 8 is a structural block diagram of an address book ranking apparatus according to another embodiment of the present invention;

FIG. 9 is a structural block diagram of an address book ranking apparatus according to another embodiment of the present invention;

FIG. 10 is a structural block diagram of an address book ranking apparatus according to still another embodiment of the present invention; and

FIG. 11 is a schematic diagram of an address book ranking apparatus according to an embodiment of the present invention.

### DETAILED DESCRIPTION

The following clearly and completely describes the technical solutions in the embodiments of the present invention with reference to the accompanying drawings in the embodiments of the present invention. The described embodiments are merely a part rather than all of the present invention. All other embodiments obtained by a person of ordinary skill in the art based on the embodiments of the present invention without creative efforts shall fall within the protection scope of the present invention.

With reference to the accompanying drawings, the following describes in detail an address book ranking method and apparatus in the embodiments of the present invention.

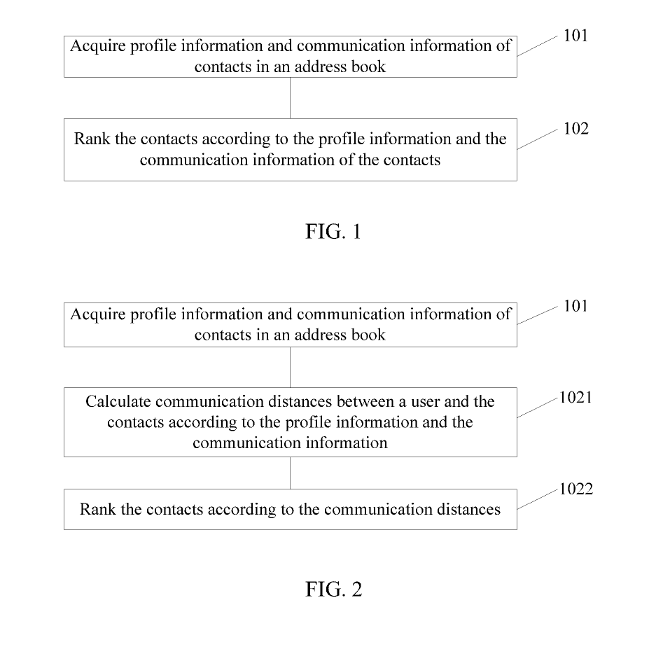

An embodiment of the present invention provides an address book ranking method. As shown in FIG. 1, the method includes the following steps.

101. Acquire profile information and communication information of contacts in an address book.

The address book records not only contact information of the contacts, such as a mobile phone number, a fixed-line number, and an E-mail address, but also the profile information, the communication information, and the like of the contacts. The profile information refers to information about the contacts in various aspects, which can reflect a degree of correlation between a user and the contacts in these aspects, and further reflects a probability that the user contacts the contacts. The profile information may include information about a group to which the contact belongs, for example, a classmate group, a colleague group, or a family group, and job information, for example, a department to which the contact belongs and position information; in addition, may further include information such as a residential address and a birthday. Preferably, the profile information may include one or more pieces of the following information of the contact: an enterprise to which the contact belongs, a department to which the contact belongs, and position information of the contact. Certainly, this embodiment of the present invention constitutes no limitation thereon.

The communication information refers to historical information about communication with the contact, which may include a communication frequency, a communication time, a communication direction, and the like between the user and the contact, and reflects a degree of closeness between the user and the contact. The communication direction refers to a direction from a communication originator to a communication receiver. A communication relationship may include information about direct communication between the contact and the user. In addition, the communication information may further include information about indirect communication between the contact and the user. Especially, indirect communication information is preferably recorded in an enterprise address book, so as to reflect a degree of closeness of an indirect connection between colleagues, thereby reflecting a probability that the user communicates with an indirect contact. For example, in an address book, Zhang San communicates with Li Si and Li Si communicates with the user, and then first-degree communication relationships are respectively established between Zhang San and Li Si, and Li Si and the user; a second-degree communication relationship is established between Zhang San and the user. By analogy, a third-degree communication relationship and the like may be further recorded. The second-degree communication relationship, the third-degree communication relationship, and the like may be recorded.

The foregoing described profile information and second-degree and above communication information reflect a historical communication relationship and a direct communication relationship between the user and the contact, but comprehensively reflect a potential connection that actually exists between the user and the contact, which may be used as important information in a subsequent contact ranking process.

102. Rank the contacts according to the profile information and the communication information of the contacts.

In this step, the profile information and the communication information may be quantized by using multiple algorithms, so as to reflect a degree of closeness of a connection with the contact.

According to the address book ranking method provided by this embodiment of the present invention, contacts are ranked based on profile information and communication information of the contacts; a ranking result comprehensively reflects a probability that a user communicates with the contacts, which can ensure that when consulting an address book, the user quickly finds a desired contact by using the ranking result.

Preferably, in another embodiment of the present invention, as shown in FIG. 2, step 102 includes the following steps 1021 and 1022.

1021. Calculate communication distances between a user and the contacts according to the profile information and the communication information.

The communication distance is a value that comprehensively reflects a probability that the user communicates with the contact. A shorter communication distance indicates a higher probability that the user contacts the contact. In this step, the communication distance may be obtained by assigning corresponding values of all profile information and all communication information and then performing calculation. This step constitutes no specific limitation on a calculation method. The following describes optional calculation manners by using only two manners.

Manner 1

A model is trained by using a linear regression method (h=Σᵢ₌₀ⁿθᵢxᵢ).

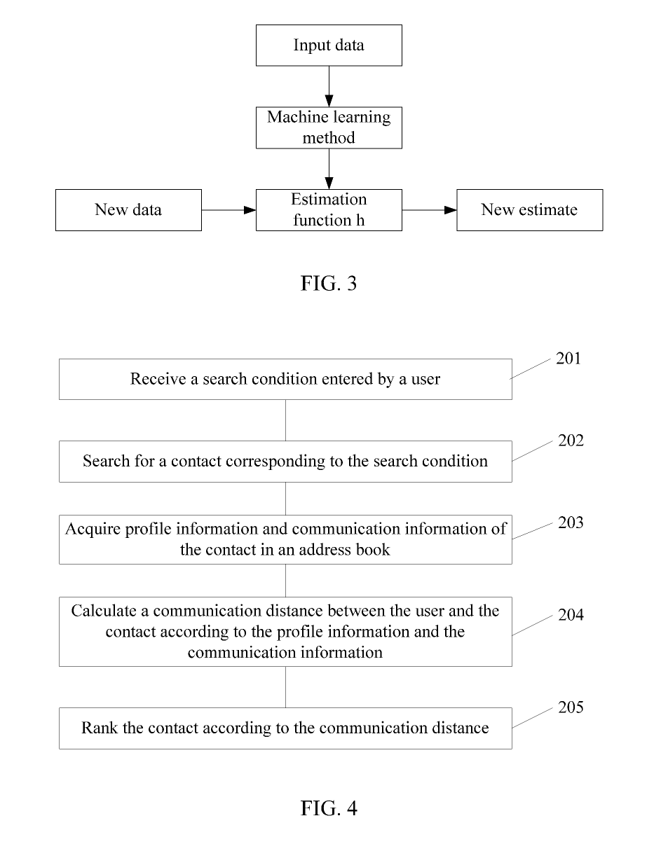

Training a model by using the linear regression method (h=Σᵢ₌₀ⁿθᵢxᵢ)is one type of training a model by using a machine learning method. In a machine learning process, a set of input data is first provided; a machine learning algorithm obtains an estimation function by means of a series of processes, where the function, for example, the foregoing linear regression estimation function h=Σᵢ₌₀ⁿθᵢxᵢ, is capable of providing a new estimate for a new set of data, and this process is also called construction of a new model. The process can be understood by referring to a block diagram shown in FIG. 3.

In linear regression, it is assumed that a feature x and a result h satisfy a linear relationship. In addition, each feature variable X, may further be first mapped into a function, and then participate into linear calculation, so that a nonlinear relationship between the feature and the result may be expressed.

In the formula h=Σᵢ₌₀ⁿθᵢxᵢ, h is used to indicate a communication distance; x₁, x₂, . . . , and xₙ are used to describe variables in the feature, for example, x₁ indicates a first-level department, x₂ indicates a second-level department, x₃ indicates a third-level department, x₄ indicates a position, and x₅ indicates a communication frequency; and an estimation function h(x)=h_{θ(x)=θ}₀=θ₁x₁=θ₂x₂=θ₃x₃=θ₄x₄=θ₅x₅ may be obtained. θ is called a parameter and is used to embody influence of each variable xᵢ in the feature, that is, whether a department relationship, a position, or a communication frequency is more important. If it is assumed that x₀=1, the estimation function h_{θ}(x)=θ^{T}X may be expressed in a manner of a vector.

The h function obtained by using the foregoing algorithm needs to be evaluated to evaluate whether 0 is appropriate. Generally, the evaluation function is called a loss function or an error function that is used to evaluate an advantage and a disadvantage of the h function, and is also called a J function. As shown in the following formula, the J function is a half of a quadratic sum of a difference between an estimated value and a true value yᵢ of xᵢ. A minimum value of J(θ) is obtained by adjusting θ. There are many adjusting methods, such as a least square method and a gradient descent method, which are not described in detail herein, and a person skilled in the art may refer to descriptions in common knowledge.

$$J ( θ ) = \frac{1}{2} {\sum }_{i = 1}^{m} {( {h}_{θ} ( {x}^{( i )} ) - {y}^{( i )} )}^{2}$$

$${min}_{θ} {J}_{θ}$$

The following uses a specific instance for description.

First, information of a contact in dimensions of a department, a communication frequency, and a position is acquired in step 101. Then, in step 1021, information about a first-level department, a second-level department, and a third-level department to which the contact belongs is separately indicated by using parameters x₁, x₂, and x₃. If the contact and a user belong to a same first-level department and a same second-level department, but do not belong to a same third-level department, values of parameters x₁, x₂ and x₃ are respectively assigned as x₁=1, x₂=1, and x₃=0. For example, the communication frequency is set to the number of communication times in a recent month, and parameters x₄, x₅, and x₆ are used to respectively indicate cases in which the number of times of communicating with the contact in the recent month is 0-5 times, 6-10 times, and more than 10 times. If the number of communication times is 0-5 times, x₄=1, x₅=0, and x₆=0; if the number of communication times is 6-10 times, x₄=0, x₅=1, and x₆=0; if the number of communication times is more than 10 times, x₄=0, x₅=0, and x₆=1. Position information is indicated by using a parameter x₇. If a position category of the contact is the same as that of the user, x₇=1; if the position category of the contact is different from that of the user, x₇=0. For example, the position category may include a technology type, a management type, a secretarial type, and the like. Features such as a communication time period, a communication frequency during the day or at night, a communication type (such as a call/short message service (SMS) message/conference), and whether belonging to a same group may be further included.

After value assignment is complete, a weight θᵢ of each parameter is obtained by using a model trained by using the linear regression h=Σᵢ₌₀ⁿθᵢxᵢ and the machine learning method, so that a distance h between the user and the contact can be calculated, according to the foregoing xᵢ assigned with a value and θᵢ obtained by training, by using the formula h=Σᵢ₌₀ⁿθᵢxᵢ

In addition, besides using the machine learning method to obtain the weight θᵢ, the weight θᵢ may also be specified for feature information in each dimension by using a preset method, so that the distance h between the user and the contact is calculated according to the formula h=Σᵢ₌₀ⁿθᵢxᵢ

Manner 2

By using another learning to rank algorithm (learning to rank), a ranking problem is converted into a classification or regression problem that can be solved by machine learning. This step does not make a specific description on this, and a person skilled in the art may train a model according to common knowledge or a common technical means.

1022. Rank the contacts according to the communication distances.

Ranking is performed according to communication distances calculated in step 1021 in ascending order. Contacts with a same communication distance may be randomly ranked or, as a supplementary, ranked alphabetically by phonetic letters of names or ranked by the number of strokes of names, which is not limited in this step.

According to the address book ranking method provided by this embodiment of the present invention, each communication distance between a user and a contact is acquired based on profile information and communication information of the contact, and then the contacts are ranked according to the communication distances. Because the communication distances comprehensively reflect a probability that the user contacts the contacts, ranking the contacts according to the communication distances can ensure that when consulting an address book, the user quickly finds a desired contact.

Preferably, in order to facilitate a user in more quickly finding a desired contact in an address book with a large capacity, in another embodiment provided by the present invention, as shown in FIG. 4, a shown ranking method includes the following steps.

201. Receive a search condition entered by a user.

For example, the search condition is phonetic letters of a contact's name, or only phonetic letters of a surname, which is not limited by the present invention, and a person skilled in the art may set the search condition according to common knowledge or a common technical means.

202. Search for a contact corresponding to the search condition.

After the search condition, for example, liliang, of the user is received in the foregoing step, contacts such as liliang, liliang, and liliang corresponding to the search condition are searched for in this step. In an address book with a large capacity, dozens or even hundreds of candidate contacts that meet the search condition may appear.

203. Acquire profile information and communication information of the contact, corresponding to the search condition, in the address book.

In this step, only the profile information and the communication information of the contact that is corresponding to the search condition are acquired.

204. Calculate a communication distance between the user and the contact according to the profile information and the communication information.

In this step, only a communication distance between the user and the contact that is corresponding to the search condition is calculated.

205. Rank the contact according to the communication distance.

For specific explanation of steps 203 to 205, refer to content in steps 101 to 103 in the foregoing embodiment. Details are not described herein again. By using steps 203 to 205, a large number of candidate contacts that meet the search condition liliang are ranked according to the communication distance, so that a candidate contact that the user may contact is located in the front. Therefore, the user quickly finds a desired contact in many contacts with a same name or a homophonic name.

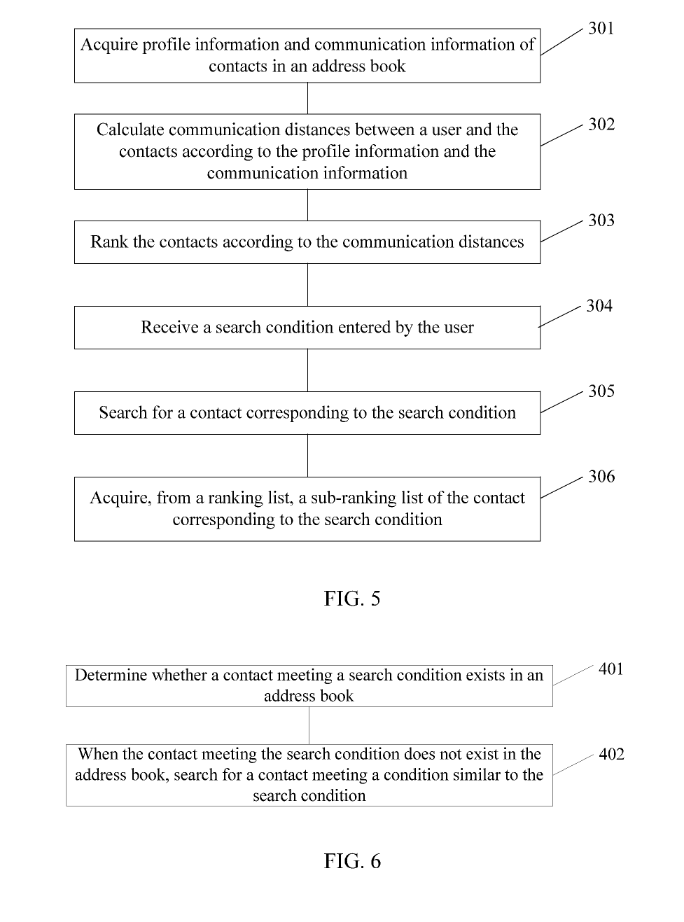

Optionally, in still another embodiment provided by the present invention, a searching step may happen after all contacts in an address book are ranked. As shown in FIG. 5, a ranking method includes the following steps.

301. Acquire profile information and communication information of contacts in an address book.

302. Calculate communication distances between a user and the contacts according to the profile information and the communication information.

303. Rank the contacts according to the communication distances.

304. Receive a search condition entered by the user.

305. Search for a contact corresponding to the search condition.

306. Acquire, from a ranking list, a sub-ranking list of the contact corresponding to the search condition.

Preferably, in still another embodiment provided by the present invention, after the receiving a search condition entered by the user, as shown in FIG. 6, a ranking method further includes the following steps.

401. Determine whether a contact meeting the search condition exists in the address book.

For example, after a search condition liliang is entered, liliang is compared with phonetic letters of contacts' names in the address book. If liliang is the same as phonetic letters of at least one contact's name, it is determined that the contact meeting the search condition exists in the address book. If no phonetic letter of a contact's name is the same as liliang, it is determined that the contact meeting the search condition does not exist in the address book.

A step of searching for a contact corresponding to the search condition is as follows.

402. When the contact meeting the search condition does not exist in the address book, search for a contact meeting a condition similar to the search condition.

For example, after the search condition liliang is entered, it is determined that no phonetic letter of a contact's name is the same as liliang. In this case, a contact meeting a condition similar to the search condition, for example, a contact whose name in phonetic letters includes lilian, li, or the like, may be searched for.

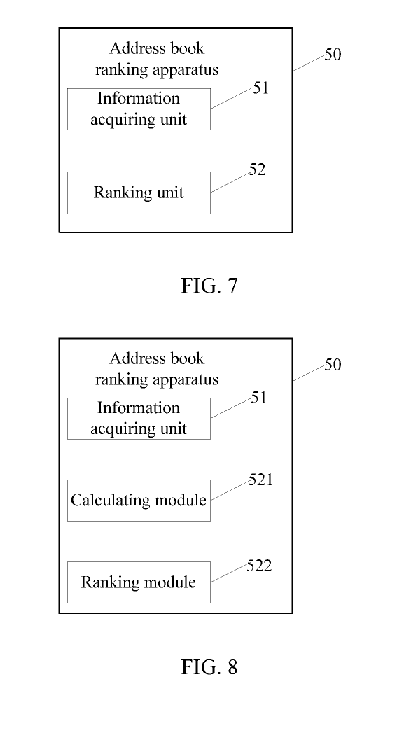

Corresponding to the foregoing address book ranking method, the present invention further provides an address book ranking apparatus 50. As shown in FIG. 7, the apparatus includes an information acquiring unit 51 configured to acquire profile information and communication information of contacts in an address book; and a ranking unit 52 configured to rank the contacts according to the profile information and the communication information of the contacts.

According to the address book ranking apparatus provided by this embodiment of the present invention, the ranking unit 52 ranks contacts based on profile information and communication information of the contacts that are acquired by the information acquiring unit 51; and a ranking result comprehensively reflects a probability that a user communicates with the contacts, which can ensure that when consulting an address book, the user quickly finds a desired contact by using the ranking result.

In addition, as shown in FIG. 8, the foregoing ranking unit 52 includes a calculating module 521 and a ranking module 522.

The calculating module 521 is configured to calculate communication distances between a user and the contacts according to the profile information and the communication information; and the ranking module 522 is configured to rank the contacts according to the communication distances.

According to the address book ranking apparatus provided by this embodiment of the present invention, the calculating module 521 acquires each communication distance between a user and a contact based on profile information and communication information of the contacts that are acquired by an information acquiring unit 51, and the ranking module 522 ranks the contacts according to the communication distances. Because the communication distances comprehensively reflect a probability that the user contacts the contacts, ranking the contacts according to the communication distances can ensure that when consulting an address book, the user quickly finds a desired contact.

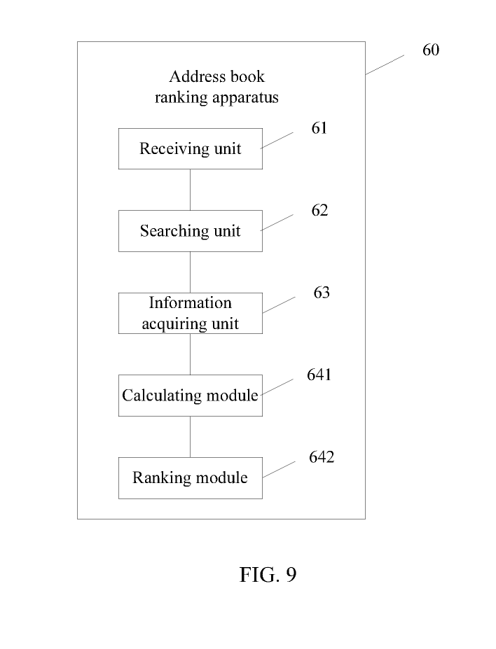

Preferably, in order to facilitate a user in more quickly finding a desired contact in an address book with a large capacity, in another embodiment provided by the present invention, as shown in FIG. 9, a shown ranking apparatus further includes a receiving unit 61 configured to, before the information acquiring unit acquires the profile information and the communication information of the contact in the address book, receive a search condition entered by the user; a searching unit 62 configured to search for a contact corresponding to the search condition; an information acquiring unit 63 configured to acquire profile information and communication information of the contact, corresponding to the search condition, in the address book, where the information acquiring unit 63 only acquires the profile information and the communication information of the contact that is corresponding to the search condition; a calculating module 641 configured to calculate communication distances between a user and the contacts according to the profile information and the communication information, where a calculating unit 64 only calculates profile information and communication information of the user and the contact that is corresponding to the search condition; and a ranking module 642 configured to rank the contacts according to the communication distances.

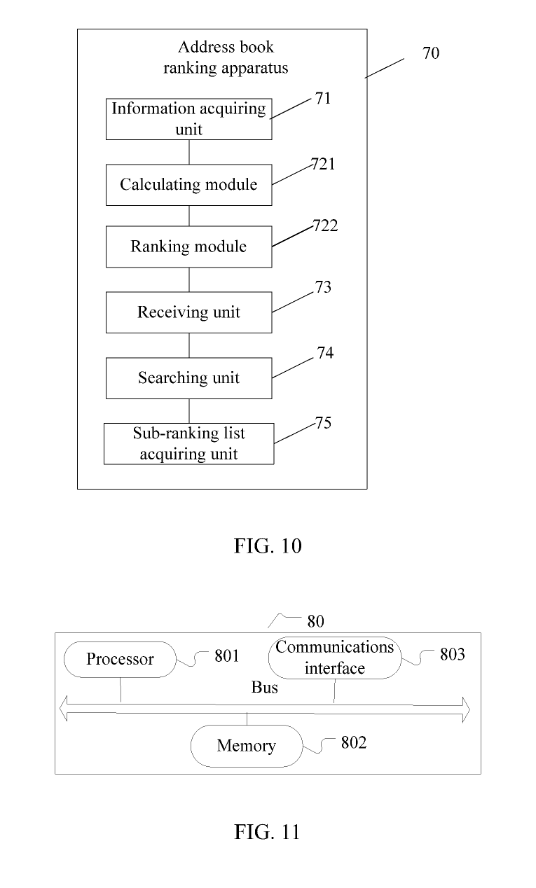

Optionally, in still another embodiment provided by the present invention, a searching unit may perform searching after a ranking module ranks all contacts in an address book. As shown in FIG. 10, the ranking apparatus 70 includes an information acquiring unit 71 configured to acquire profile information and communication information of contacts in an address book; a calculating module 721 configured to calculate communication distances between a user and the contacts according to the profile information and the communication information; a ranking module 722 configured to rank the contacts according to the communication distances; a receiving unit 73 configured to, after the ranking module ranks the contacts according to the communication distances, receive a search condition entered by the user; a searching unit 74 configured to search for a contact corresponding to the search condition; and a sub-ranking list acquiring unit 75 configured to acquire, from the ranking list, a sub-ranking list of the contact corresponding to the search condition.

Preferably, in still another embodiment provided by the present invention, a ranking apparatus further includes a determining unit, which is configured to, after a receiving unit receives a search condition entered by a user, determine whether a contact meeting the search condition exists in an address book; then, a searching unit is configured to, when the determining unit determines that the contact meeting the search condition does not exist in the address book, search for a contact meeting a condition similar to the search condition.

An embodiment of the present invention further provides an address book ranking apparatus 80. As shown in FIG. 11, the apparatus includes at least one processor 801, a memory 802, a communications interface 803, and a bus. The processor 801, the memory 802, and the communications interface 803 are connected to each other and communicate with each other by using the bus. The bus may be an Industry Standard Architecture (ISA) bus, a Peripheral Component Interconnect (PCI) bus, an Extended Industry Standard Architecture (EISA) bus, or the like. The bus may be classified into an address bus, a data bus, a control bus, and so on. For ease of illustration, only one bold line is used in FIG. 11 to represent the bus, which, however, does not mean there is only one bus or only one type of bus.

The memory 802 is configured to store executable program code, where the program code includes computer operation instructions. The memory 802 may include a high-speed random-access memory (RAM) memory, and may further include a non-volatile memory, for example, at least one disk memory.

The communications interface 803 is mainly configured to implement communication between the address book ranking apparatus in this embodiment and another device or apparatus.

The processor 801 may be a central processing unit (CPU), or an application specific integrated circuit (ASIC), or one or more integrated circuits configured to implement the embodiments of the present invention.

In an embodiment, the processor 801 runs a program corresponding to executable program code by reading the executable program code stored in the memory 802, so as to acquire profile information and communication information of contacts in an address book; and rank the contacts according to the profile information and the communication information of the contacts.

Optionally, the profile information includes one or more pieces of the following information of the contact: an enterprise to which the contact belongs, a department to which the contact belongs, and a position of the contact. Certainly, this embodiment of the present invention constitutes no limitation thereon.

According to the address book ranking apparatus provided by this embodiment of the present invention, the processor 801 ranks contacts based on profile information and communication information of the contacts; and a ranking result comprehensively reflects a probability that a user communicates with the contacts, which can ensure that when consulting an address book, the user quickly finds a desired contact by using the ranking result.

In another embodiment, the processor 801 runs a program corresponding to executable program code by reading the executable program code stored in the memory 802, so as to calculate communication distances between a user and the contacts according to the profile information and the communication information; and rank the contacts according to the communication distances.

According to the address book ranking apparatus provided by this embodiment of the present invention, the processor 801 acquires each communication distance between a user and a contact based on profile information and communication information of the contact, and then the contacts are ranked according to the communication distances. Because the communication distances comprehensively reflect a probability that the user contacts the contacts, ranking the contacts according to the communication distances can ensure that when consulting an address book, the user quickly finds a desired contact.

In still another embodiment, the processor 801 runs a program corresponding to executable program code by reading the executable program code stored in the memory 802, so as to, before the acquiring profile information and communication information of contacts in an address book, receive a search condition entered by the user; search for a contact corresponding to the search condition; and further acquire profile information and communication information of a contact that is corresponding to the search condition and in the address book.

According to the address book ranking apparatus provided by this embodiment of the present invention, a user quickly finds a desired contact in many contacts with a same name or a homophonic name.

In still another embodiment, the processor 801 runs a program corresponding to executable program code by reading the executable program code stored in the memory 802, so as to, after the ranking the contacts according to the communication distances, receive a search condition entered by the user; search for a contact corresponding to the search condition; and acquire, from the ranking list, a sub-ranking list of the contact corresponding to the search condition.

According to the address book ranking apparatus provided by this embodiment of the present invention, a user quickly finds a desired contact in many contacts with a same name or a homophonic name.

In still another embodiment, the processor 801 runs a program corresponding to executable program code by reading the executable program code stored in the memory 802, so as to, after the receiving a search condition entered by the user, determine whether a contact meeting the search condition exists in the address book; and when the contact meeting the search condition does not exist in the address book, further search for a contact meeting a condition similar to the search condition.

It should be noted that the foregoing processor 801, in addition to having the functions described above, may be further configured to implement other procedures in the foregoing method embodiments, and details are not described herein again.

A person of ordinary skill in the art may understand that all or a part of the processes of the methods in the embodiments may be implemented by a computer program instructing relevant hardware. The program may be stored in a computer readable storage medium. When the program runs, the steps of the methods in the embodiments are performed. The foregoing storage medium includes any medium that can store program code, such as a read-only memory (ROM), a RAM, a magnetic disk, or an optical disc.

The foregoing descriptions are merely exemplary implementations of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention is subject to the protection scope of the claims.

What is claimed is:

1. An address book ranking method, comprising:
acquiring profile information and communication information of contacts in an address book; and
ranking the contacts according to the profile information and the communication information of the contacts.

2. The method according to claim 1, wherein ranking the contacts according to the profile information and the communication information of the contacts comprises:
calculating communication distances between a user and the contacts according to the profile information and the communication information; and
ranking the contacts according to the communication distances.

3. The method according to claim 1, wherein the profile information comprises one or more pieces of the following information of the contact: an enterprise to which the contact belongs, a department to which the contact belongs, and a position of the contact.

4. The method according to claim 2, wherein before acquiring the profile information and the communication information of the contacts in the address book, the method further comprises:
receiving a search condition entered by the user; and
searching for a contact corresponding to the search condition,
wherein acquiring the profile information and the communication information of the contacts in the address book comprises acquiring profile information and communication information of the contact, corresponding to the search condition, in the address book.

5. The method according to claim 2, wherein after ranking the contacts according to the communication distances, the method further comprises:
receiving a search condition entered by the user;
searching for a contact corresponding to the search condition; and
acquiring, from the ranking list, a sub-ranking list of the contact corresponding to the search condition.

6. The method according to claim 4, wherein after receiving the search condition entered by the user, the method comprises determining whether a contact meeting the search condition exists in the address book, and wherein searching for the contact corresponding to the search condition comprises searching for a contact meeting a condition similar to the search condition when the contact meeting the search condition does not exist in the address book.

7. The method according to claim 5, wherein after receiving the search condition entered by the user, the method comprises determining whether a contact meeting the search condition exists in the address book, and wherein searching for the contact corresponding to the search condition comprises searching for a contact meeting a condition similar to the search condition when the contact meeting the search condition does not exist in the address book.

8. An address book ranking apparatus, comprising:
an information acquiring unit configured to acquire profile information and communication information of contacts in an address book; and
a ranking unit configured to rank the contacts according to the profile information and the communication information of the contacts.

9. The apparatus according to claim 8, wherein the ranking unit comprises a calculating module and a ranking module, wherein the calculating module is configured to calculate communication distances between a user and the contacts according to the profile information and the communication information, and wherein the ranking module is configured to rank the contacts according to the communication distances.

10. The apparatus according to claim 8, wherein the profile information comprises one or more pieces of the following information of the contact: an enterprise to which the contact belongs, a department to which the contact belongs, and a position of the contact.

11. The apparatus according to claim 9, further comprising:
a receiving unit configured to, before the information acquiring unit acquires the profile information and the communication information of the contact in the address book, receive a search condition entered by the user; and
a searching unit configured to search for a contact corresponding to the search condition, wherein the information acquiring unit is configured to acquire profile information and communication information of the contact, corresponding to the search condition, in the address book.

12. The apparatus according to claim 9, further comprising:
a receiving unit configured to, after the ranking module ranks the contacts according to the communication distances, receive a search condition entered by the user;
a searching unit configured to search for a contact corresponding to the search condition; and
a sub-ranking list acquiring unit configured to acquire, from the ranking list, a sub-ranking list of the contact corresponding to the search condition.

13. The apparatus according to claim 11, further comprising a determining unit configured to, after receiving the search condition entered by the user, determine whether a contact meeting the search condition exists in the address book, wherein the searching unit is configured to, when the determining unit determines that the contact meeting the search condition does not exist in the address book, search for a contact meeting a condition similar to the search condition.

14. The apparatus according to claim 12, further comprising a determining unit configured to, after receiving the search condition entered by the user, determine whether a contact meeting the search condition exists in the address book, wherein the searching unit is configured to, when the determining unit determines that the contact meeting the search condition does not exist in the address book, search for a contact meeting a condition similar to the search condition.
